(19) United States
(12) Patent Application Publication
(10) Pub. No.: US 2014/0187699 A1
(43) Pub. Date: Jul. 3, 2014

(54) COMPOSITION COMPRISING FLUORINATED OLEFIN/VINYL ALCOHOL COPOLYMER AND ALKOXYSILANE, COMPOUND, CURED PRODUCT FORMED FROM SAID COMPOSITION, AND FILM COMPRISING SAID CURED PRODUCT

(71) Applicant: ASAHI GLASS COMPANY, LIMITED, Chiyoda-ku (JP)

(72) Inventor: Norihide SUGIYAMA, Tokyo (JP)

(73) Assignee: ASAHI GLASS COMPANY, LIMITED, Chiyoda-ku (JP)

(21) Appl. No.: 14/196,323

(22) Filed: Mar. 4, 2014

Related U.S. Application Data
(63) Continuation of application No. PCT/JP2012/075854, filed on Oct. 4, 2012.

(30) Foreign Application Priority Data
Oct. 5, 2011 (JP) 2011-220922

(51) Int. Cl. C09D 127/18; B29C 39/38; B29C 39/14

(52) U.S. Cl. CPC C09D 127/18; B29C 39/14; B29C 39/38
USPC 524/377; 264/216

(57) ABSTRACT

To provide a composition from which a transparent and tough film can be produced, a cured product formed from the composition, and a film comprising the cured product.

A composition comprising a fluorinated olefin/vinyl alcohol copolymer, a predetermined alkoxysilane compound or its oligomer, a solvent and a hydrolysis/condensation catalyst, wherein the solvent is at least one member selected from the group consisting of a C₃₋₁₀ ketone compound, a C₂₋₁₀ nitrile compound, a C₃₋₁₀ amide compound in which a hydrogen atom bonded to the nitrogen atom may be substituted by a C₁₋₅ alkyl group, and a predetermined ether compound.

### TECHNICAL FIELD

The present invention relates to a composition comprising a fluorinated olefin/vinyl alcohol copolymer and an alkoxysilane compound, a cured product formed from the composition, and a film comprising the cured product.

### BACKGROUND ART

For a liquid crystal display, an organic EL display, electronic paper and a touch panel, a glass plate has been used, and it has been studied to replace the glass plate with transparent plastic having characteristics such as lightness in weight, flexibility and impact resistance. Further, also in the field of a solar cell, reduction in the film thickness, weight saving, impartment of flexibility, etc. by a thin film solar cell have been studied, and a transparent film excellent in the weather resistance is required.

As a material excellent in the weather resistance, a fluorinated polymer composition containing silicon oxide has been known. For example, a composition comprising polysilicic acid and a tetrafluoroethylene/2-hydroxyethyl vinyl ether copolymer has been known (Patent Documents 1 and 2). Further, a fluorinated coating composition obtained by reacting a fluoroolefin copolymer having repeating units based on a hydroxyalkyl crotonate with a silane compound or its partial condensate has been known (Patent Document 3).

### PRIOR ART DOCUMENTS

### Patent Documents

Patent Document 1: U.S. Pat. No. 3,429,845
Patent Document 2: U.S. Pat. No. 3,429,846
Patent Document 3: JP-A-4-173881

### DISCLOSURE OF INVENTION

### Technical Problem

However, from compositions as disclosed in Patent Documents 1 to 3, a coating film is formed by coating the substrate surface, but no transparent film could be produced. According to findings by the present inventor, in order to produce a transparent film with a decreased haze by the method as disclosed in Patent Document 1 or 2, it is necessary to increase the amount of use of polysilicic acid or the amount of use of acetic acid, however, particularly a film having a thickness of at least 100 μm is insufficient in the transparency, and such an increase is unfavorable in view of work environment.

It is an object of the present invention to provide a composition from which a transparent and tough film can be produced, a cured product formed from the composition, and a film comprising the cured product.

### Solution to Problem

The present invention provides a composition comprising a fluorinated olefin/vinyl alcohol copolymer and an alkoxysilane compound, a cured product formed from the composition, and a film comprising the cured product, according to the following [1] to [17].

[1] A composition comprising a fluorinated olefin/vinyl alcohol copolymer, an alkoxysilane compound, a solvent and a hydrolysis/condensation catalyst;

wherein the alkoxysilane compound is a compound represented by the following formula (1) and/or its oligomer; and

the solvent is at least one member selected from the group consisting of a C₃₋₁₀ ketone compound, a C₂₋₁₀ nitrile compound, a C₃₋₁₀ amide compound in which a hydrogen atom bonded to the nitrogen atom may be substituted by a C₁₋₅ alkyl group, and an ether compound represented by the following formula (2):

R²ₓSi(OR³)₄₋ₓ (1)

wherein x is an integer of from 0 to 2, R² is a group selected from the group consisting of a hydrogen atom, a C₁₋₁₀ alkyl group, a C₂₋₁₀ fluoroalkyl group and a C₆₋₁₂ aryl group, and R³ is a C₁₋₆ alkyl group or a cycloalkyl group;

R⁴—(OCHR⁶CH₂)ₙ—OR⁵ (2)

wherein R⁴ is a C₁₋₅ alkyl group, R⁵ is a hydrogen atom or a C₁₋₅ alkyl group, R⁶ is a hydrogen atom or a hydroxy group, and n is an integer of from 1 to 5.
[2] The composition according to the above [1], wherein R⁶ in the formula (2) is a hydrogen atom.
[3] The composition according to the above [1] or [2], wherein the fluorinated olefin/vinyl alcohol copolymer has a weight average molecular weight of from 50,000 to 1,000,000.
[4] The composition according to any one of the above [1] to [3], wherein the fluorinated olefin/vinyl alcohol copolymer is a copolymer containing repeating units represented by the following formula (3) and repeating units represented by the following formula (4):

-(CF₂CFX¹)— (3)

—(CH₂CH(OH))— (4)

wherein X¹ is a fluorine atom, a chlorine atom, a trifluoromethyl group or —OCₐF₂ₐ₊₁ (wherein a is an integer of from 1 to 3).
[5] The composition according to the above [4], wherein in the fluorinated olefin/vinyl alcohol copolymer, the molar ratio of the repeating units represented by the formula (3) to the repeating units represented by the formula (4) is from 40/60 to 60/40.
[6] The composition according to the above [4] or [5], wherein in the fluorinated olefin/vinyl alcohol copolymer, the alternating copolymerization ratio of the repeating units represented by the formula (3) and the repeating units represented by the formula (4) is at least 95%.
[7] The composition according to any one of the above [1] to [6], wherein the solvent contains at least one member selected from the group consisting of acetone, acetonitrile, 2-methoxypropionitrile, N,N-dimethylformamide, ethylene glycol monomethyl ether, ethylene glycol monoethyl ether, ethylene glycol dimethyl ether, diethylene glycol dimethyl ether, propylene glycol monomethyl ether, propylene glycol monoethyl ether and propylene glycol monobutyl ether.
[8] The composition according to any one of the above [1] to [7], wherein the alkoxysilane compound is at least one member selected from the group consisting of methyltrimethoxysilane, phenyltrimethoxysilane, tetramethoxysilane, tridecafluorooctyltrimethoxysilane and their oligomers.
[9] The composition according to any one of the above [1] to [8], wherein the mass ratio of the fluorinated olefin/vinyl alcohol copolymer to the alkoxysilane compound is from 5:95 to 95:5, and the mass ratio of the total mass of the fluorinated olefin/vinyl alcohol copolymer and the alkoxysilane compound to the solvent is from 95:5 to 1:99.
[10] The composition according to any one of the above [1] to [9], wherein the hydrolysis/condensation catalyst is a sulfonic acid compound.
[11] The composition according to any one of the above [1] to [10], which further contains water.
[12] A cured product obtained by heating the composition as defined in any one of the above [1] to [11] to remove the solvent.
[13] The cured product according to the above [12], wherein the temperature at which the composition is heated is from 40 to 200° C.
[14] A film comprising the cured product as defined in the above [12] or [13].
[15] A method for producing a film, which comprises forming the composition as defined in any one of the above [1] to [11] into a film by a casting method, followed by heating to remove the solvent.
[16] A method for producing a composition, which comprises dissolving a fluorinated olefin/vinyl alcohol copolymer and an alkoxysilane compound in at least one solvent selected from the group consisting of a C₃₋₁₀ ketone compound, a C₂₋₁₀ nitrile compound, a C₃₋₁₀ amide compound in which a hydrogen atom bonded to the nitrogen atom may be substituted by a C₁₋₅ alkyl group, and an ether compound represented by the following formula (2), to obtain s solution, and adding a hydrolysis/condensation catalyst and water to the obtained solution to let the alkoxysilane compound be partially hydrolyzed/condensed, wherein the alkoxysilane compound is a compound represented by the following formula (1) and/or its oligomer:

R²ₓSi(OR³)₄₋ₓ (1)

wherein x is an integer of from 0 to 2, R² is a group selected from the group consisting of a hydrogen atom, a C₁₋₁₀ alkyl group, a C₂₋₁₀ fluoroalkyl group and a C₆₋₁₂ aryl group, and R³ is a C₁₋₆ alkyl group or a cycloalkyl group;

R⁴—(OCHR⁶CH₂)ₙ—OR⁵ (2)

wherein R⁴ is a C₁₋₅ alkyl group, R⁵ is a hydrogen atom or a C₁₋₅ alkyl group, R⁶ is a hydrogen atom or a hydroxy group, and n is an integer of from 1 to 5.
[17] The method for producing a composition according to the above [16], wherein R⁶ in the formula (2) is a hydrogen atom.

### Advantageous Effects of Invention

According to the composition of the present invention, a transparent and tough film can be produced. Particularly when a copolymer having a high molecular weight and high alternating copolymerizability is used as the fluorinated olefin/vinyl alcohol copolymer, a film excellent in the heat resistance can be produced.

### BRIEF DESCRIPTION OF DRAWINGS

FIG. 1 is a drawing illustrating light transmittances of a film produced in Example 1 and a film produced in Production Example 1.

FIG. 2 is a drawing illustrating the surface of a film produced in Example 1 observed with a scanning electron microscope (SEM).

FIG. 3 is a drawing illustrating the surface of a film produced in Comparative Example 1 observed with a scanning electron microscope (SEM).

### DESCRIPTION OF EMBODIMENTS

In this specification, “monomer” is a compound to be used at the time of polymerization, and is a compound forming repeating units after the polymerization.

### [Fluorinated Olefin/Vinyl Alcohol Copolymer]

The fluorinated olefin/vinyl alcohol copolymer in the present invention is preferably a copolymer containing repeating units represented by the above formula (3) and repeating units represented by the above formula (4).

The weight average molecular weight (Mw) of the fluorinated olefin/vinyl alcohol copolymer is preferably from 50,000 to 1,000,000, more preferably from 85,000 to 1,000,000, further preferably from 85,000 to 700,000, particularly preferably from 85,000 to 300,000. When Mw of the fluorinated olefin/vinyl alcohol copolymer is at least the lower limit value, entanglement of molecular chains is sufficiently secured, and formation of a tough film or sheet tends to be easy. On the other hand, when Mw of the fluorinated olefin/vinyl alcohol copolymer is at most the upper limit value, flowability will be secured at the time of formation, and formation of a homogeneous film or sheet tends to be easy. The weight average molecular weight (Mw) of the fluorinated olefin/vinyl alcohol copolymer can be measured by GPC using polystyrene standard.

The molecular weight distribution (Mw/Mn) of the fluorinated olefin/vinyl alcohol copolymer is preferably from 1 to 5, particularly preferably from 1 to 2. With a fluorinated olefin/vinyl alcohol copolymer having Mw/Mn being at most the above upper limit value, a tough film can be formed with a small gel substance.

The fluorinated olefin/vinyl alcohol copolymer may be any of random, alternating and block copolymers, and in view of excellent heat resistance and chemical resistance, is preferably a random or alternating copolymer, particularly preferably an alternating copolymer. An alternating copolymer has high weather resistance and water resistance since repeating units represented by the formula (3) and repeating units represented by the formula (4) are uniformly arranged. A film comprising a cured product formed from a composition containing a fluorinated olefin/vinyl alcohol copolymer with high uniformity of the composition of the copolymer and with high transparency, and an alkoxysilane compound, can be obtained. Further, since hydroxy groups are uniformly distributed, the reactivity tends to be stable.

The fluorinated olefin/vinyl alcohol copolymer is preferably an alternating copolymer having an alternating copolymerization ratio of the repeating units represented by the formula (3) and the repeating units represented by the formula (4) of at least 95%. When the alternating copolymerization ratio is at least 95%, a cured product formed from the composition containing the fluorinated olefin/vinyl alcohol copolymer and an alkoxysilane compound tends to have favorable heat resistance, whether resistance and water resistance. The alternating copolymerization ratio is a proportion of the number of combinations such that repeating units based on different monomers are adjacent to each other to the total number of combinations of adjacent two repeating units. For example, in a case where the copolymer is a copolymer represented by 34344343434 (wherein 3 represents a repeating unit represented by the formula (3) and 4 represents a repeating unit represented by the formula (4)), the number of combinations of the adjacent two repeating units is 10, and the number of combinations such that repeating units based on different monomers are adjacent to each other is 9, and accordingly the alternating copolymerization ratio is 90%.

In the fluorinated olefin/vinyl alcohol copolymer, the molar ratio ((3)/(4)) of the repeating units represented by the formula (3) to the repeating units represented by the formula (4) is preferably from 40/60 to 60/40, more preferably from 45/55 to 55/45, particularly preferably 50/50.

To produce the fluorinated olefin/vinyl alcohol copolymer, (1) a method of hydrolyzing a fluorinated olefin/vinyl acetate copolymer in the presence of an acid or a base, or (2) a method of deprotecting a fluorinated olefin/vinyl ether copolymer, may be mentioned. In the present invention, in view of the high alternating copolymerizability, preferred is the method (2). The method (1) may, for example, be a method disclosed in M. Ragazzini et. al., Eur. Polym. J., 3, 5 (1967). In this method, a fluorinated olefin and vinyl acetate are copolymerized using ammonium persulfate as an initiator to obtain a fluorinated olefin/vinyl acetate copolymer, and then the copolymer is hydrolyzed with sodium hydroxide. The obtained fluorinated olefin/vinyl alcohol copolymer is a random copolymer.

As the polymerization method for the fluorinated olefin/vinyl acetate copolymer or the fluorinated olefin/vinyl ether copolymer to be the material in the method (1) or (2), bulk polymerization, suspension polymerization, emulsion polymerization, solution polymerization or the like may be employed. In view of excellent productivity, solution polymerization or emulsion polymerization is preferred, and with a view to obtaining a copolymer having a high molecular weight, emulsion polymerization is particularly preferred.

In the case of solution polymerization, the polymerization medium may, for example, be an aromatic compound such as xylene or toluene, an alcohol such as t-butyl alcohol, an ester or a fluorochlorocarbon. The amount of the polymerization medium is preferably from 10 to 200 mass %, particularly preferably from 50 to 100 mass % to the total mass of the monomers to be used for the copolymerization.

Any of the above copolymerization methods may be carried out by any of batch system, continuous system and semicontinuous system.

As the copolymerization temperature, an optimum temperature may properly be selected depending upon the polymerization initiation source, the polymerization medium, etc., and it is preferably from −30° C. to 150° C., more preferably from 0° C. to 100° C., particularly preferably from 20° C. to 70° C.

The copolymerization pressure may also be properly selected depending upon the polymerization initiation source, the polymerization medium, etc., and is preferably from 0.1 to 10 MPa, particularly preferably from 0.2 to 3 MPa.

The copolymerization time is preferably from 1 to 24 hours, more preferably from 2 to 12 hours.

The molecular weight of the copolymer may be adjusted by controlling the proportion of the monomers to the polymerization medium or by employing a chain transfer agent.

As an example for a case where the method (2) is carried out by emulsion polymerization, a process comprising the following steps (i) and (ii) may be mentioned.

Step (i): A step of copolymerizing a fluorinated olefin represented by the following formula (6) (hereinafter sometimes referred to as “fluorinated olefin (6)”) and a vinyl ether represented by the following formula (7) (hereinafter sometimes referred to as “vinyl ether (7)”) in an aqueous medium in the presence of an emulsifier to obtain a fluorinated olefin/vinyl ether copolymer (hereinafter sometimes referred to as “copolymer (B)”).

Step (ii): A step of substituting R¹ in each repeating unit based on the vinyl ether (7) in the copolymer (B) by a hydrogen atom to obtain a fluorinated olefin/vinyl alcohol copolymer (hereinafter sometimes referred to as “copolymer (A)”).

CF₂═CFX (6)

CH₂═CHOR¹ (7)

wherein X is a fluorine atom, a chlorine atom, a trifluoromethyl group or —OCₐF₂ₐ₊₁ (wherein a is an integer of from 1 to 3); and R¹ is a group to be substituted by a hydrogen atom in the step (ii).

The fluorinated olefin (6) is preferably a fluorinated alkene or a perfluoro(alkyl vinyl ether). The fluorinated alkene may be tetrafluoroethylene, chlorotrifluoroethylene or hexafluoropropylene. The perfluoro(alkyl vinyl ether) may be perfluoro(propyl vinyl ether). Among them, in view of excellent heat resistance of the obtainable fluorinated olefin/vinyl alcohol copolymer, preferred is tetrafluoroethylene or chlorotrifluoroethylene, particularly preferred is tetrafluoroethylene. Such fluorinated olefins may be used alone or in combination of two or more.

The vinyl ether (7) is not particularly limited so long as R¹ in the formula (7) can be substituted by a hydrogen atom. Preferably, R¹ is a group selected from the group consisting of C₄₋₁₂ tertiary alkyl group or alkoxyalkyl group, a C₄₋₆ alicyclic hydrocarbon group containing an etheric oxygen atom, a C₆₋₁₀ aryl group, and —Si (R⁵)₃ (wherein R⁵ is a C₁₋₁₀ alkyl group or an aryl group). Among them, in view of availability, preferred is a tertiary alkyl group particularly a tertiary alkyl group represented by —CR⁷R⁸R⁹ (wherein each of R⁷, R⁸ and R⁹ which are independent of each other, is a C₁₋₃ alkyl group), a methyl group substituted by a C₁₋₆ alkoxy group, a tetrahydrofuryl group, a tetrahydropyranyl group, or a trialkylsilyl group wherein R⁵ is a C₁₋₆ alkyl group or an aryl group, particularly preferred is a tertiary alkyl group represented by —CR⁷R⁸R⁹.

The vinyl ether (7) is preferably t-butyl vinyl ether, 1,1-dimethylpropyl vinyl ether, methoxymethyl vinyl ether, tetrahydrofuryl vinyl ether, tetrahydropyranyl vinyl ether, vinyloxytrimethylsilane or vinyloxydimethylphenylsilane, and in view of availability, particularly preferably t-butyl vinyl ether. Such vinyl ethers (7) may be used alone or in combination of two or more.

The alternating copolymerizability of the fluorinated olefin (6) and the vinyl ether (7) is high, and the alternating copolymerization ratio of the obtainable fluorinated olefin/vinyl ether copolymer (hereinafter sometimes referred to as “copolymer (B)”) is at least 95% as obtained by probability calculation from the copolymerization reactivity ratio of the both.

By the alternating copolymerization ratio of the copolymer (B) being at least 95%, a copolymer (A) having an alternating copolymerization ratio of repeating units based on the fluorinated olefin (6) and repeating units based on the vinyl alcohol (7) of at least 95% can be obtained. A copolymer (A) having a high alternating copolymerization ratio is excellent in the heat resistance, the weather resistance and the water resistance, since the repeating units based on the fluorinated olefin (6) and the repeating units based on the vinyl alcohol (7) are uniformly arranged. Further, for example, in a case where a cured product is to be formed by reacting a curing agent to hydroxy groups which the copolymer (A) has, since the hydroxy groups are uniformly distributed, the reactivity of the hydroxy groups tends to be more stable.

In the step (i), in addition to the fluorinated olefin (6) and the vinyl ether (7), a vinyl ether represented by the following formula (8) (hereinafter sometimes referred to as “vinyl ether (8)”) may further be copolymerized.

CH₂═CHOR¹⁰ (8)

wherein R¹⁰ is a group selected from the group consisting of a C₁₋₆ primary or secondary alkyl group and a C₆₋₁₂ cycloalkyl group, which may be substituted by a hydroxy group or a fluorine atom.

The vinyl ether (8) is a vinyl ether in which R¹⁰ is inert in the subsequent step (ii). R¹⁰ being inert in the step (ii) means that R¹⁰ is not changed under reaction conditions under which R¹ in the vinyl ether (7) is substituted by a hydrogen atom. However, R¹⁰ may be an active group under conditions other than the reaction conditions under which R¹ is substituted by a hydrogen atom. By using the vinyl ether (8), in the step (ii), R¹⁰ in the repeating units based on the vinyl ether (8) in a copolymer (B) is not changed, and the repeating units based on the vinyl ether (8) are maintained as they are in the obtainable copolymer (A). The hydrophilicity of the obtainable copolymer (A) can be adjusted by adjusting the proportion of the vinyl ether (7) to the vinyl ether (8).

R¹⁰ in the vinyl ether (8) is preferably a C₁₋₆ primary or secondary alkyl group or a group having at least one hydrogen atom in such an alkyl group substituted by a substituent. The substituent is preferably a hydroxy group or a fluorine atom.

The vinyl ether (8) may, for example, be specifically an alkyl vinyl ether such as methyl vinyl ether, ethyl vinyl ether, n-butyl vinyl ether, isobutyl vinyl ether or cyclohexyl vinyl ether; a functional group-containing vinyl ether such as hydroxyethyl vinyl ether or hydroxybutyl vinyl ether; or a fluorinated vinyl ether such as heptafluoropentyl vinyl ether.

In a case where the vinyl ether (8) is used, a copolymer (B) in which either vinyl ether of the vinyl ether (7) and the vinyl ether (8) and the fluorinated olefin (6) are alternately polymerized is obtained. Since the vinyl ether (7) and the vinyl ether (8) are substantially equal in the polymerization reactivity, whether each of both sides of each repeating unit based on the fluorinated olefin (6) in the copolymer (B) is the repeating unit based on the vinyl ether (7) or the repeating unit based on the vinyl ether (8) is a matter of odds. In a case where the vinyl ether (8) is used, no substitution reaction will take place in the repeating units based on the vinyl ether (8) in the copolymer (B). Accordingly, by adjusting the proportion of the vinyl ether (7) and the vinyl ether (8), the proportion of the repeating units based on the vinyl alcohol in the copolymer (A) after the step (ii) can be adjusted. Thus, by adjusting the amount of hydroxy groups in the copolymer (A), the hydrophilicity of the copolymer (A) can be adjusted.

In a case where the vinyl ether (8) is not used, the molar ratio ((6)/(7)) of the fluorinated olefin (6) to the vinyl ether (7) to be used for the copolymerization is preferably from 40/60 to 60/40, more preferably from 45/55 to 55/45, particularly preferably 50/50. When the molar ratio ((6)/(7)) is within the above range, an alternating copolymer in which the fluorinated olefin (6) and the vinyl ether (7) are alternately copolymerized is likely to be obtained.

Further, in a case where the vinyl ether (8) is used, the molar ratio ((6)/((7)+(8))) of the fluorinated olefin (6) to the total amount of the vinyl ether (7) and the vinyl ether (8) to be used for the copolymerization is preferably from 40/60 to 60/40, more preferably from 45/55 to 55/45, particularly preferably 50/50. When the molar ratio ((6)/((7)+(8))) is within the above range, an alternating copolymer in which the fluorinated olefin (6) and the vinyl ether (7) or the vinyl ether (8) are alternately copolymerized is likely to be obtained. Further, in such a case, the molar ratio ((7)/(8)) of the vinyl ether (7) to the vinyl ether (8) is preferably from 45/5 to 10/40, particularly preferably from 40/10 to 25/25.

The aqueous medium to be used for the step (i) is preferably water alone in view of availability. The amount of use of the aqueous medium is, as the mass ratio of the vinyl ether (7) to the aqueous medium, from 5/95 to 70/30, preferably from 10/90 to 50/50, particularly preferably from 10/90 to 35/65. When the amount of the vinyl ether (7) is at least the lower limit value, the polymerization reaction will proceed, and when it is at most the upper limit value, the emulsion state will stably be maintained.

As the emulsifier to be used in the step (i), various surfactants such as a cationic surfactant, an anionic surfactant and a nonionic surfactant may be used, and among them, preferred is an anionic surfactant, such as a sulfonic acid surfactant, a carboxylic acid surfactant or a phosphate surfactant.

The sulfonic acid surfactant may, for example, be sodium lauryl sulfate or sodium dodecylbenzene sulfonate.

The carboxylic acid surfactant is more preferably a fluorinated carboxylic acid surfactant in view of affinity with the fluorinated olefin (6), and is particularly preferably a compound represented by the following formula (9) in view of availability:

R¹¹—(CH₂)ₘ—COOX² (9)

wherein R¹¹ is a C₁₋₉ perfluoroalkyl group which may contain an oxygen atom, m is an integer of from 0 to 2, and X² is a hydrogen atom, NH₄ or an alkali metal atom.

With a view to forming a favorable micell structure, R¹¹ preferably has from 5 to 9 carbon atoms. Further, in view of a high effect to prevent a chain transfer reaction during the polymerization, m is preferably 0. X² is preferably a hydrogen atom or NH₄, particularly preferably NH₄.

The emulsifier is preferably ammonium perfluorooctanoate, F(CF₂)₂OCF₂CF₂OCF₂COONH₄, F(CF₂)₃OCF₂CF₂OCF₂COONH₄ or F(CF₂)₄OCF₂CF₂OCF₂COONH₄.

The amount of use of the emulsifier may properly be changed depending upon its type, reaction conditions, etc. In a case where the vinyl ether (8) is not used, it is preferably from 0.005 to 5 mass %, particularly preferably from 0.1 to 5 mass % to the total mass of the fluorinated olefin (6) and the vinyl ether (7). In a case where the vinyl ether (8) is used, it is preferably from 0.005 to 5 mass %, particularly preferably from 0.1 to 5 mass % to the total mass of the fluorinated olefin (6), the vinyl ether (7) and the vinyl ether (8). When the amount is at least the lower limit value, a stable emulsion state can be formed, and when it is at most the upper limit value, polymerization will proceed stably without vigorous bubbling.

The step (i) is carried out in the presence of a radical polymerization initiation source and as the case requires, a basic compound in the reaction system. The radical polymerization initiation source may be a radical polymerization initiator or ionizing radiation.

The radical polymerization initiator is preferably a water-soluble initiator suitable for emulsion polymerization. As the water-soluble initiator, an organic peroxide such as (3-carboxypropionyl)peroxide (HOC(═O)CH₂CH₂C(═O)OOC(═O)CH₂CH₂C(═O)OH) or bis(4-carboxybutyryl)peroxide (HOC(═O)CH₂CH₂CH₂C(═O)OOC(═O)CH₂CH₂CH₂C(═O)OH) or an inorganic peroxide such as ammonium persulfate or potassium persulfate may be used alone or in combination. Further, a redox initiator comprising the above peroxide and a reducing agent such as sodium bisulfite or sodium thiosulfate in combination, or an inorganic initiator comprising the above redox initiator in the coexistence with a small amount of ion, ferrous salt, silver nitrate or the like may be mentioned. Among the above radical polymerization initiators, in view of handling efficiency, etc., preferred is an inorganic peroxide, particularly preferred is ammonium persulfate. Such radical polymerization initiators may be used alone or in combination of two or more. Further, it may be added all at once at the initial stage of the reaction, or may be added intermittently or continuously during the reaction.

The amount of use of the radical polymerization initiator may properly be changed depending upon its type, the reaction conditions, etc. In a case where the vinyl ether (8) is not used, it is preferably from 0.005 to 5 mass %, particularly preferably from 0.05 to 0.5 mass % to the total mass of the fluorinated olefin (6) and the vinyl ether (7). In a case where the vinyl ether (8) is used, it is preferably from 0.005 to 5 mass %, particularly preferably from 0.05 to 0.5 mass % to the total mass of the fluorinated olefin (6), the vinyl ether (7) and the vinyl ether (8).

The copolymerization reaction in the step (i) may be carried out either under basic conditions or under acidic conditions. However, under acidic conditions, isomerization, decomposition or cationic homopolymerization is likely to occur as compared with under basic conditions. Accordingly, in order that polymerization stably proceeds, the polymerization is preferably carried out under basic conditions, and it is particularly preferred to add a basic compound to the reaction system to let the reaction system be under basic conditions, for example, to adjust the pH of the aqueous phase to be from 8 to 9.

Such a basic compound is preferably a water-soluble inorganic compound suitable for emulsion polymerization, such as an alkali metal salt or an ammonium salt of carbonic acid or phosphoric acid. In view of availability, preferred is sodium carbonate, disodium hydrogen carbonate, potassium carbonate, dipotassium hydrogen carbonate, ammonium carbonate, sodium phosphate, disodium hydrogen phosphate, sodium dihydrogen phosphate, potassium phosphate, dipotassium hydrogen phosphate, potassium dihydrogen phosphate, ammonium phosphate or the like. Such basic compounds may be used alone or in combination of two or more.

The amount of use of the basic compound may properly be changed depending upon its type, reaction conditions, etc. In a case where the vinyl ether (8) is not used, it is preferably from 0.005 to 5 mass %, particularly preferably from 0.1 to 5 mass % to the total mass of the fluorinated olefin (6) and the vinyl ether (7). In a case where the vinyl ether (8) is used, it is preferably from 0.005 to 5 mass %, particularly preferably from 0.1 to 5 mass % to the total mass of the fluorinated olefin (6), the vinyl ether (7) and the vinyl ether (8).

As the reaction temperature for the copolymerization reaction, an optimum value may properly be selected depending upon the polymerization initiation source, and it is preferably from 5 to 95° C. The reaction pressure for the copolymerization reaction may also be properly selected depending upon the polymerization initiation source, and is preferably from 0.1 to 10 MPa, more preferably from 0.2 to 3 MPa. The reaction time for the copolymerization reaction is preferably from 1 to 24 hours, particularly preferably from 2 to 12 hours.

In order to adjust the molecular weight of the copolymer (B), a chain transfer agent may further be added.

The weight average molecular weight (Mw) of the copolymer (B) is preferably from 50,000 to 1,000,000, more preferably from 85,000 to 1,000,000, further preferably from 85,000 to 700,000, particular preferably from 85,000 to 300,000. When Mw of the copolymer (B) is at least the lower limit value, entanglement of the molecular chains will sufficient be secured, and formation of a tough film or sheet tends to be easy. On the other hand, when Mw of the copolymer (B) is at most the upper limit value, flowability will be secured at the time of forming, and formation of a homogenous film or sheet tends to be easy. The weight average molecular weight (Mw) of the copolymer (B) can be measured by GPC using polystyrene standard.

The molecular weight distribution (Mw/Mn) of the copolymer (B) is preferably from 1 to 5, particularly preferably from 1 to 2. With a copolymer (B) having Mw/Mn of at most the upper limit value, a tough film can be formed with a small gel substance.

The step (ii) is a step of substituting R¹ in each repeating unit based on the vinyl ether (7) in the copolymer (B) obtained in the step (i) by a hydrogen atom to obtain a fluorinated olefin/vinyl alcohol copolymer. In this step, the repeating units based on the vinyl ether (7) are converted into repeating units based on a vinyl alcohol, whereby a copolymer (A) having repeating units based on the fluorinated olefin (6) and repeating units based on a vinyl alcohol is obtained. In a case where the copolymer (B) contains repeating units based on the vinyl ether (8), R¹⁰ in each repeating units based on the vinyl ether (8) is maintained as it is without being changed, and accordingly a copolymer (A) having repeating units based on the fluorinated olefin (6) repeating units based on a vinyl alcohol and repeating units based on the vinyl ether (8) is obtained.

As a method to substitute R¹ by a hydrogen atom, reaction employing an acid, heat or light may be employed. Particularly, it is preferred to substitute R¹ by a hydrogen atom by an acid, whereby the obtainable copolymer (A) will not substantially be colored. Such an acid may, for example, be an inorganic acid such as sulfuric acid, hydrochloric acid or nitric acid, or an organic acid such as acetic acid, butyric acid or trifluoroacetic acid.

The reaction by an acid may be carried out in an aqueous system or in a non-aqueous system, and for example, (1) reaction in a mixed solution of sulfuric acid/ethanol/water, (2) reaction in a mixed solution of hydrochloric acid/dioxane or (3) reaction in a mixed solution of trifluoroacetic acid/methylene chloride is preferred.

Further, it may be carried out by using a photoacid generator which generates an acid by irradiation with light. The photoacid generator may, for example, be an onium salt, a halogen-containing compound, a diazoketone compound, a sulfone compound or a sulfonic acid compound. Specific examples include diphenyl iodonium triflate, triphenyl sulfonium triflate, phenyl-bis(trichloromethyl)-s-triazine, methoxyphenyl-bis(trichloromethyl)-s-triazine, 4-trisphenacylsulfone and 1,8-naphthalene dicarboxylic acid imide triflate.

In the step (ii), depending upon the application of the copolymer (A), the reaction may be completed before the entire R¹ in the copolymer (B) is substituted, to obtain a copolymer (A) having repeating units based on the fluorinated olefin (6), repeating units based on the vinyl ether (7) and repeating units based on a vinyl alcohol. The hydrophilicity, the crystallinity, etc. of the obtainable copolymer (A) can be adjusted by adjusting the proportion of the repeating units based on the vinyl ether (7) and the repeating units based on a vinyl alcohol by completing the deprotection reaction in the middle.

### [Alkoxysilane Compound]

The alkoxysilane compound in the present invention is a compound represented by the following formula (1) and/or its oligomer:

R²ₓSi(OR³)₄₋ₓ (1)

wherein x is an integer of from 0 to 2, R² is a group selected from the group consisting of a hydrogen atom, a C₁₋₁₀ alkyl group, a C₂₋₁₀ fluoroalkyl group and a C₆₋₁₂ aryl group, and R³ is a C₁₋₆ alkyl group or a cycloalkyl group.

The alkoxysilane compound is preferably tetraalkoxysilane, trialkoxysilane or dialkoxysilane, and may be its oligomer. The oligomer is preferably, for example, a dimer to octamer, and is preferably a dimer, a trimer, a tetramer or the like. The oligomer may be a mixture of a dimer to an octamer, and in such a case, particularly preferred is a dimer to a tetramer on average. The tetraalkoxysilane may be tetramethoxysilane or tetraethoxysilane. The trialkoxysilane may be methyltrimethoxysilane, ethyltrimethoxysilane, tridecafluorooctyltrimethoxysilane or phenyltrimethoxysilane. The dialkoxysilane may be methylphenyldimethoxysilane, tetrabutoxysilane, tetrahexoxysilane or diphenyldimethoxysilane. Among them, preferred is methyltrimethoxysilane, phenyltrimethoxysilane, tetramethoxysilane, tridecafluorooctyltrimethoxysilane or its oligomer. Such alkoxysilane compounds may be used alone or in combination of two or more.

### [Composition Comprising Fluorinated Olefin/Vinyl Alcohol Copolymer and Alkoxysilane Compound]

The composition in the present invention is a composition comprising the fluorinated olefin/vinyl alcohol copolymer, the alkoxysilane compound, a solvent and a hydrolysis/condensation catalyst, wherein the solvent is at least one member selected from the group consisting of a C₃₋₁₀ ketone compound, a C₂₋₁₀ nitrile compound, a C₃₋₁₀ amide compound in which a hydrogen atom bonded to the nitrogen atom may be substituted by a C₁₋₅ alkyl group, and an ether compound represented by the formula (2). The composition may further contain water.

The alkoxy group in the alkoxysilane compound is usually hydrolyzed in the presence of water and converted into a Si—OH group (silanol group). Such silanol groups are intermolecularly reacted in the alkoxysilane compound to form a Si—O—Si bond. In the presence of a hydrolysis/condensation catalyst, the rate of the hydrolysis of the alkoxy group and/or condensation of the silanol groups will improve. In the composition of the present invention, such silanol groups and hydroxy groups in the fluorinated olefin/vinyl alcohol copolymer are mutually interacted, and it is considered that by such interaction, the copolymer and a polysiloxane keep a compatible state to obtain a transparent cured product.

As the solvent in the present invention, at least one member selected from the group consisting of a C₃₋₁₀ ketone compound, a C₂₋₁₀ nitrile compound, a C₃₋₁₀ amide compound in which a hydrogen atom bonded to the nitrogen atom may be substituted by a C₁₋₅ alkyl group, and an ether compound represented by the formula (2) is used.

R⁴—(OCHR⁶CH₂)ₙ—OR⁵ (2)

wherein R⁴ is a C₁₋₅ alkyl group, R⁵ is a hydrogen atom or a C₁₋₅ alkyl group, R⁶ is a hydrogen atom or a hydroxy group, and n is an integer of from 1 to 5. R⁶ is preferably a hydrogen atom in view of the solubility of the fluorinated olefin/vinyl alcohol copolymer, and is preferably a hydroxy group in view of the storage stability of the composition of the present invention.

By using such a solvent, phase separation or the like will not occur in production of a film comprising a cured product formed from the composition of the present invention as described hereinafter, whereby a transparent film can be obtained. The reason why the phase separation will not occur is not clearly understood but is estimated such that the fluorinated olefin/vinyl alcohol copolymer is soluble in such a solvent and the solvent will not inhibit the interaction of the silanol groups and the hydroxy groups in the copolymer.

The C₃₋₁₀ ketone compound is preferably an aliphatic ketone or an alicyclic ketone. The aliphatic ketone may be acetone, methyl ethyl ketone, methyl isobutyl ketone or diacetone alcohol. The alicyclic ketone may be cyclohexanone.

The C₂₋₁₀ nitrile compound may be acetonitrile, propionitrile, benzonitrile or 2-methoxypropionitrile.

The C₃₋₁₀ amide compound in which a hydrogen atom bonded to the nitrogen atom may be substituted by a C₁₋₅ alkyl group may be N,N-dimethylformamide or N,N-dimethylacetamide.

The ether compound represented by the formula (2) is preferably an ethylene glycol monoether, an ethylene glycol diether or a propylene glycol monoether. The ethylene glycol monoether may be ethylene glycol monomethyl ether, ethylene glycol monoethyl ether or diethylene glycol monomethyl alcohol. The ethylene glycol diether may be ethylene glycol dimethyl ether or diethylene glycol dimethyl ether. The propylene glycol monoether may be propylene glycol monomethyl ether, propylene glycol monoethyl ether or propylene glycol monobutyl ether.

Among them, preferred is at least one member selected from the group consisting of acetone, acetonitrile, 2-methoxypropionitrile, N,N-dimethylformamide, ethylene glycol monomethyl ether, ethylene glycol monoethyl ether, ethylene glycol dimethyl ether, diethylene glycol dimethyl ether, propylene glycol monomethyl ether, propylene glycol monoethyl ether and propylene glycol monobutyl ether.

The mass ratio of the amount of use of the fluorinated olefin/vinyl alcohol copolymer to the alkoxysilane compound is preferably from 5:95 to 95:5, particularly preferably from 30:70 to 90:10. Further, the mass ratio of the total mass of the fluorinated olefin/vinyl alcohol copolymer and the alkoxysilane compound to the solvent is preferably from 95:5 to 1:99. In a case where a film comprising a cured product formed from the composition of the present invention is to be produced, since the amount of the solvent is preferably smaller, the mass ratio is more preferably from 95:5 to 10:90, particularly preferably from 95:5 to 20:80.

The hydrolysis/condensation catalyst in the present invention is preferably a compound which promotes condensation of molecules of the alkoxysilane compound.

As the hydrolysis/condensation catalyst, an organic metal compound such as tetraisopropyl titanate, tetrabutyl titanate, titanium acetylacetonate, aluminum triisobutoxide, aluminum triisopropoxide, tris(acetylacetonate) aluminum, diisopropoxy(ethylacetoacetate) aluminum, dibutyltin dilaurate or dibutyltin dioctate, or an organic acid having an acid dissociation constant higher than that of acetic acid in a non-aqueous solvent system, is used. Preferred is methanesulfonic acid, benzenesulfonic acid, p-toluenesulfonic acid, oxalic acid, trichloroacetic acid, trifluoroacetic acid, pentafluorobenzoic acid, hexafluoroglutaric acid, octafluoroadipic acid or the like, and with a view to promoting condensation even with a small amount of use, particularly preferred is p-toluenesulfonic acid.

The amount of use of the hydrolysis/condensation catalyst is preferably from 0.01 to 1 mass % to the alkoxysilane compound, and in view of the curing rate and the storage stability of the composition, it is particularly preferably from 0.05 to 0.2 mass %.

In the present invention, if the amount of use of water is large, the amount of Si—OH groups present tends to be large, the interaction between molecules of the polysiloxane tends to be strong, the fluorinated olefin/vinyl alcohol copolymer tends to undergo phase separation, and clouding tends to occur.

Accordingly, the amount of use of water in the present invention is preferably as small as possible, whereby a cured product formed from the composition of the present invention tends to have favorable transparency. It is preferably at most 1 equivalent amount, more preferably at most 0.5 equivalent amount, particularly preferably at most 0.1 equivalent amount per 1 equivalent amount of the alkoxy groups in the alkoxysilane compound. Water may be added simultaneously with addition of the hydrolysis/condensation catalyst or immediately before production of a cured product, however, preferably added immediately before production of a cured product in view of the storage stability.

The composition of the present invention may contain, as an additive, fine particles of e.g. silica, alumina or zirconia as the case requires, and such is useful to increase the hardness of a cured product. Particularly when colloidal silica is used, a cured product having high hardness can be obtained without impairing the transparency. The amount of addition is preferably from 0.1 to 20 mass %, particularly preferably from 1 to 10 mass % in a cured product obtained in the present invention.

Further, addition of a basic silicon compound such as a silazane such as hexamethyldisilazane, hexamethyltricyclosilazane or polyhydrosilazane or an aminosilane such as aminopropyltrimethoxysilane is also useful. Particularly when such a compound is used in combination with the titanate compound as the hydrolysis/condensation catalyst, a cured product having high hardness while maintaining transparency can be obtained.

[Cured Product Formed from Composition of the Present Invention]

The composition of the present invention is not cured at room temperature since it is diluted with a solvent and is stable for one month or longer in a sealed state, but is cured by removing the solvent.

A cured product formed from the composition of the present invention (hereinafter sometimes referred to as “cured product”) is obtained by removing the solvent from the composition. As a method of removing the solvent, pressure reduction or heating may be mentioned, and a method of only reducing the pressure, a method of only heating, or a method of heating under reduced pressure may be mentioned. By heating, simultaneously with removal of the solvent, the condensation reaction of molecules of the alkoxysilane compound or the dehydrative condensation reaction with the hydroxy groups in the fluorinated olefin/vinyl alcohol copolymer will further proceed, whereby a hard cured product will be obtained. Preferred is a method of only heating in view of simplicity of the apparatus. The heating temperature is preferably from 40 to 200° C., and the heating time is preferably from 1 to 100 hours. With a view to obtaining a smooth cured product having favorable outer appearance without microvoids, microcracks or the like, it is preferred that the composition is heated at from 40 to 60° C. for from 1 to 5 hours, the temperature is gradually increased to heat the composition at from 100 to 150° C. for from 1 to 5 hours, and as the case requires, the composition is further pressurized and heated at about 200° C. for from 10 minutes to one hour. Here, removal of the solvent means that the amount of the solvent contained in the cured product is at most 1 mass % in the composition.

The shape of the cured product is not limited and may be a form of particles, fibers, a membrane, a film or the like.

To obtain a cured product having a desired shape, (1) a method of casting the composition of the present invention into a mold and removing the solvent, (2) a method of applying the composition of the present invention to a substrate to form a coating film and removing the solvent may, for example, be mentioned.

To apply the composition of the present invention, a known means may properly be employed. The application method may be a spin coating method, a wipe coating method, a spray coating method, a squeegee coating method, a dip coating method, a die coating method, an ink jet method, a flow coating method, a roll coating method, a casting method, a Langmuir Blodgett method or a gravure coating method, and particularly for production of a cured product having a thickness of at most 10 μm, it is preferably a spin coating method, and for production of a cured product having a thickness of from 10 to 1,000 μm, it is preferably a casting method.

Production of a film can be carried out by the method (2). A film can be produced by a process of applying the composition of the present invention to a substrate to form a coating film, removing the solvent and separating the cured product from the substrate. The separated cured product may be reheated. The reheating temperature is preferably at least the boiling point of the solvent used.

As the material of the substrate, a sheet or plate made of a fluororesin such as PTFE, PFA or ETFE; or a non-adhesive resin such as a polyethylene, a polypropylene or a cycloolefin polymer may be mentioned.

The thickness of the film is preferably from 1 to 1,000 μm in view of hardness.

Production of a membrane can be carried out by the method (2). The membrane can function as a surface-treated layer of a substrate. The substrate is selected depending upon the purpose of use, and a metal, a resin, glass, a ceramic or a composite material thereof may be mentioned. The material of the substrate is preferably glass or a transparent resin substrate. Glass may, for example, be soda lime glass, borosilicate glass, alkali-free glass, crystal glass or quartz glass. As the transparent resin substrate, polycarbonate may be mentioned.

The cured product has a pencil hardness of at least 4H, preferably at least 6H, as measured in accordance with JIS K5600-5-4. A film comprising a cured product is not only excellent in mechanical properties but also excellent in the transparency, and it has, for example, a transmittance at a wavelength of from 350 to 800 nm of at least 80% and a total light transmittance of at least 90%, and is useful for a touch panel of a liquid crystal display, an organic EL display, etc. and a protective cover for a solar cell.

### EXAMPLES

Now, the present invention will be described in further detail with reference to Examples. However, it should be understood that the present invention is by no means restricted thereto.

### [Measurement Method]

Measurement methods used in Examples are as follows.

(Weight average molecular weight (Mw), number average molecular weight (Mn) and molecular weight distribution (Mw/Mn))

The weight average molecular weight (Mw), the number average molecular weight (Mn) and the molecular weight distribution (Mw/Mn) of a copolymer obtained in each Example were measured by gel permeation chromatography (GPC) as calculated as polystyrene gel, using a high performance GPC apparatus “HLC-8220GPC” manufactured by TOSOH CORPORATION. As an eluent, tetrahydrofuran was used.

### (Structure and Composition of Copolymer)

The structure and the composition of a copolymer obtained in each Example were identified and calculated by measurement of ¹H NMR and ¹⁹F NMR spectra.

### (Heat Characteristics of Copolymer)

Of a copolymer obtained in each Example, the glass transition point (Tg) was measured by a differential scanning calorimetry “Q100” manufactured by TA Instruments Japan Inc., and the 10% weight reduction temperature (Td10) was measured by a thermogravimetry/differential thermal analyzer “TG-DTA2000SA” manufactured by Bruker AXS K.K.

### (Haze of Film)

Measured by a haze meter (manufactured by BYK Guardner)

### (Light Transmittance of Film)

The light transmittance at from 350 to 800 nm was measured by a spectrophotometer.

### (Pencil Hardness of Film)

Measured in accordance with JIS K5600-5-4.

### (Tensile Test of Film)

Using a dumbbell cutter, a dumbbell (parallel portion length: 16 mm, width: 4 mm, entire length: 5 cm) of JIS K-6251-8 was punched out to prepare a test specimen for tensile test. A tensile test was carried out at a temperature of 25° C. at a rate of 10 mm/min using a compact table-top tester (apparatus name: EZ Test) manufactured by Shimadzu Corporation.

### Preparation Example 1

### Preparation of Copolymer (A1)

### (Step (i))

Into an autoclave equipped with a stirrer made of stainless steel having an internal capacity of 1 L (withstand pressure: 3.4 MPa), 500.0 g of deionized water, 125.0 g of t-butyl vinyl ether (hereinafter referred to as “TBVE”) as vinyl ether (7), 2.5 g of ammonium perfluorooctanoate as an emulsifier, 9.1 g of disodium hydrogen phosphate and 5.0 g of ammonium persulfate were charged, followed by freeze-deaeration with liquid nitrogen to remove oxygen in the system.

Then, 126.5 g of tetrafluoroethylene (hereinafter referred to as “TFE”) as the fluorinated olefin (6) was introduced into an autoclave and heated to 50° C. The pressure at this time was 2.43 MPa. Then, the reaction was continued for 7.5 hours, and at the time when the pressure was decreased to 1.09 MPa, the autoclave was cooled with water, and the unreacted gas was purged to terminate the reaction. The obtained polymer solution was poured into methanol, the formed copolymer (B1) was precipitated, followed by vacuum drying. The yield of copolymer (B1) was 69.0 g, and the reaction rate of the monomers was 66%.

Of the obtained copolymer (B1), Mw was 136,000, Mn was 65,000 and Mw/Mn was 2.1. From a ¹H NMR spectrum and a ¹⁹F NMR spectrum, the copolymer compositional ratio was TFE/TBVE=49/51 (mol %). Further, by calculation from the copolymerization reactivity ratio of both the monomers, the copolymer was found to substantially have an alternating structure (alternating copolymerization ratio: at least 95%).

(Step (ii))

Into a 100 mL flask, 4.0 g of the copolymer (B1), 4.0 g of 36 wt % concentrated hydrochloric acid and 52 g of ethanol were put, followed by stirring under heating at an internal temperature of 78° C. to carry out deprotecting reaction. The reaction was continued for 8 hours, the reaction liquid was dropped into water to precipitate a copolymer, which was washed with water and vacuum dried at 90° C. to obtain 2.5 g of copolymer (A1). No coloring was observed in this step.

From the results of measurement of a ¹H NMR spectrum and a ¹⁹F NMR spectrum of the above copolymer (B1) and the obtained copolymer (A1), copolymer (A1) was confirmed that at least 99% of R¹ (t-butyl groups) were substituted by hydrogen by hydrolysis to form hydroxy groups (repeating units in which R¹ was substituted by hydrogen will hereinafter sometimes be referred to as “VAI”), and the copolymer compositional ratio was TFE/VAI=46/54 (mol %), Mw was 110,000, Mn was 39,000, and Mw/Mn=2.8. Further, Tg was 90° C., and Td10 was 394° C.

### Preparation Example 2

### Preparation of Copolymer (A2)

Into an autoclave equipped with a stirrer made of stainless steel having an internal capacity of 1 L, 354 g of methyl acetate, 63 g of vinyl acetate (hereinafter referred to as “VAc”) and 2.3 g of a 50% 1,1,1,2,2,3,3,4,4,5,5,6,6-tridecafluorohexane solution of t-butyl peroxypivalate (hereinafter referred to as “PBPV”) were charged, followed by freeze deaeration with liquid nitrogen to remove oxygen in the system. Then, 179 g of TFE was introduced into the autoclave and heated to 55° C. The reaction was continued for 10 minutes, the autoclave was cooled with water, and unreacted gas was purged to terminate the reaction. The obtained polymer solution was poured into methanol, the formed copolymer was precipitated, followed by vacuum drying to obtain copolymer (B2) as a solid. The yield of copolymer (B2) was 110 g, and the reaction rate of the monomers was 45%.

Of the obtained copolymer (B2), Mw was 278,000, Mn was 84,000 and Mw/Mn was 3.3. From a ¹H NMR spectrum and a ¹⁹F NMR spectrum, the copolymer compositional ratio was TFE/VAc=50/50 (mol %). Further, by calculation from the copolymerization reactivity ratio of both the monomers, the alternating copolymerization ratio of copolymer (B2) was from 80 to 85%.

Then, in a 100 mL flask, 4.1 g of the above copolymer (B2), 4.0 g of 36 wt % concentrated hydrochloric acid and 52 g of ethanol were put, followed by stirring under heating at an internal temperature of 78° C. to carry out deprotection reaction. The reaction was continued for 32 hours, the reaction liquid was dropped in water to precipitate a copolymer, which was washed with water and vacuum dried at 90° C. to obtain 2.7 g of copolymer (A2).

From a ¹H NMR spectrum and a ¹⁹F NMR spectrum of the above copolymer (B2) and the obtained copolymer (A2), it was confirmed that at least 99% of acetyl groups were substituted by hydrogen by hydrolysis to form hydroxy groups. Of copolymer (A2), the copolymer compositional ratio was TFE/VAI=50/50 (mol %), Mw was 275,000, Mn was 74,000 and Mw/Mn=3.7. Further, Tg was 85° C., Td10 was 379° C., and the decomposition temperature was lower by about 20° C. than copolymer (A1).

### Production Example 1

### Production of Film

1.0 g of copolymer (A1) prepared in Preparation Example 1 was poured into a container in which 9.0 g of ethanol was put, and dissolved to obtain a solution. The solution was subjected to filtration through a membrane filter made of polytetrafluoroethylene, followed by a casting method to obtain a film having a thickness of 0.1 mm. With respect to the obtained film, a tensile test and measurement of the pencil hardness were carried out, whereupon the elastic modulus was 1,004 MPa, the breaking stress was 35 MPa, the elongation was 8%, and the pencil hardness was 4H.

### Example 1

0.6 g of copolymer (A1) prepared in Preparation Example 1 was dissolved at room temperature in 2.4 g of ethylene glycol dimethyl ether (hereinafter sometimes referred to as “MG”). To the obtained solution, 0.4 g of methyl silicate oligomer (tetramer on average, manufactured by TAMA CHEMICALS CO., LTD., tradename: MS51) as the alkoxysilane compound and 0.1 g of diethylene glycol dimethyl ether (hereinafter sometimes referred to as “DG”) containing 0.6 mg of p-toluenesulfonic acid monohydrate as the hydrolysis/condensation catalyst (water: 0.037 equivalent amount per 1 equivalent amount of alkoxy groups in the alkoxysilane compound) were added, followed by stirring at room temperature for one hour to prepare composition (C1). Composition (C1) was poured into a box-shape container (7 cm square, depth: 1 cm) prepared by a fluororesin release film (manufactured by Asahi Glass Company, Limited, tradename: AFLEX) and heated in a nitrogen atmosphere at 45° C. for 2 hours and then at 60° C. for 2 hours to obtain a film having a thickness of 0.1 mm. The film was separated from the container and further heated at 80° C. for one hour and then at 100° C. for one hour. The obtained film had an amount as calculated as SiO₂ of 23%.

The results of evaluation of the obtained film were as follows.

(1) The haze was 2.9%.

(2) Light transmittance

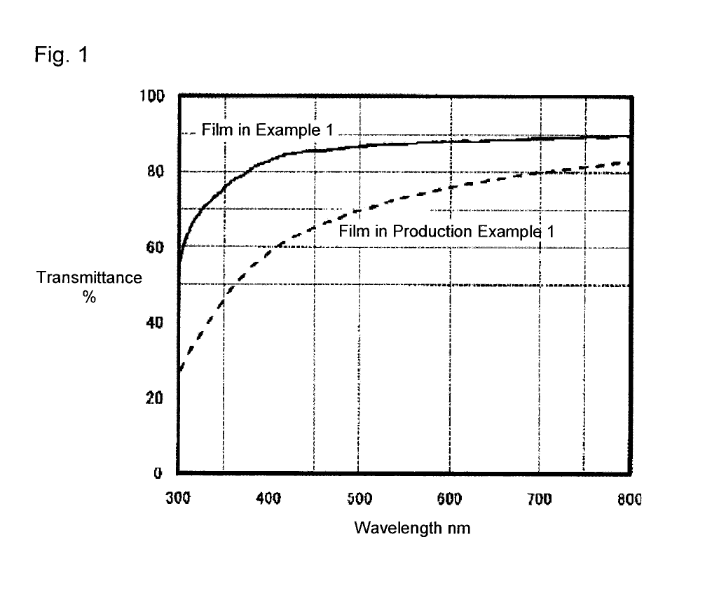

Light transmittances of the film produced in Example 1 and the film comprising the copolymer (A1) produced in Production Example 1 at from 350 to 800 nm are shown in FIG. 1. As evident from FIG. 1, the former has a transmittance of at least 80% at wavelengths of at least 370 nm and had remarkably improved transparency as compared with the latter film.

(3) The pencil hardness was 6H, and the film was superior to the film (pencil hardness: 4H) comprising the copolymer (A1) produced in Production Example 1.

(4) As the results of the tensile test, the elastic modulus was 1,290 MPa, the breaking stress was 33 MPa, the elongation was 21%, and the film had a sufficient strength as a film. It had an elastic modulus and an elongation improved as compared with the film comprising the copolymer (A1) produced in Production Example 1.

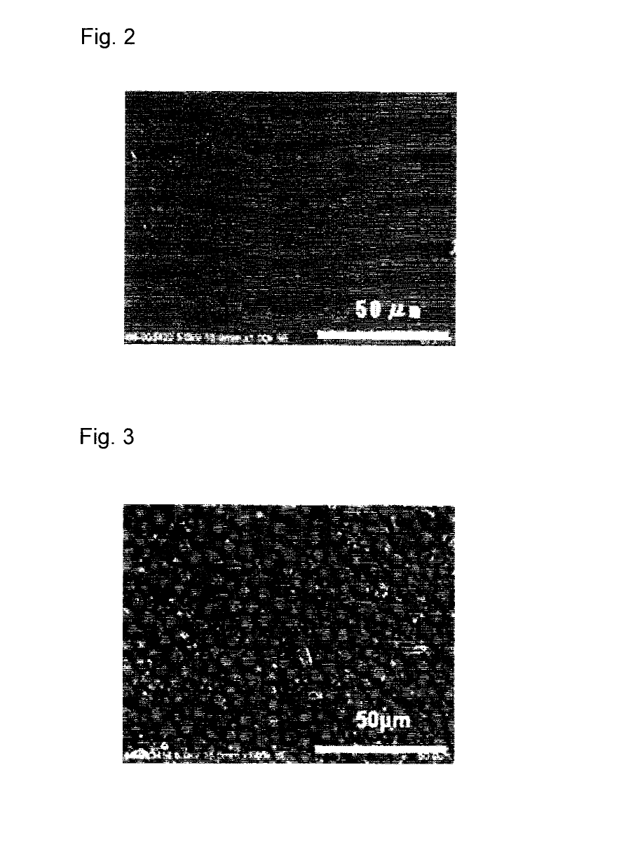

Further, the surface of the film was observed with a scanning electron microscope (SEM, magnification: 1,000 times), whereupon it was smooth as shown in FIG. 2, and no phase separation structure or the like was observed. Here, a cured product in which no phase separation structure is confirmed as observed with a scanning electron microscope (SEM, magnification: 1,000 times) is sometimes called a hybrid.

### Example 2

0.4 g of copolymer (A1) obtained in Preparation Example 1 was dissolved at room temperature in 2.5 g of MG. Then, 0.5 g of methyl silicate oligomer (tetramer on average, manufactured by TAMA CHEMICALS CO., LTD., tradename: MS51) as the alkoxysilane compound and 0.1 g of DG containing 0.7 mg of p-toluenesulfonic acid monohydrate as the hydrolysis/condensation catalyst (water: 0.035 equivalent amount per 1 equivalent amount of alkoxy groups in the alkoxysilane compound) were added, followed by stirring at room temperature for one hour to prepare composition (C2). Using composition (C2), a film having a thickness of 0.1 mm was obtained in the same manner as in Example 1. The obtained film had an amount as calculated as SiO₂ of 34%.

With respect to the obtained film, the same measurement as in Example 1 was carried out.

(1) The haze was 1.6%.

(2) The film had a pencil hardness of 9H, which was improved as compared with the film comprising the copolymer (A1) produced in Production Example 1.

(3) As the results of the tensile test, the elastic modulus was 1,190 MPa, the breaking stress was 27 MPa, the elongation was 4%, and the film had a sufficient strength as a film.

### Example 3

0.3 g of copolymer (A2) obtained in Preparation Example 2 was dissolved at room temperature in 2.5 g of MG. Then, 0.6 g of methyltrimethoxysilane as the alkoxysilane compound and 0.1 g of DG containing 0.7 mg of p-toluenesulfonic acid monohydrate as the hydrolysis/condensation catalyst (water: 0.003 equivalent amount per 1 equivalent amount of alkoxy groups in the alkoxysilane compound) were added. Then, 0.12 g of pure water (water: 0.5 equivalent amount per 1 equivalent amount of alkoxy groups in the alkoxysilane compound) was slowly dropped, followed by stirring at room temperature for one hour to prepare composition (C3). Using composition (C3), a film having a thickness of 0.12 mm was obtained in the same manner as in Example 1. The obtained film had an amount as calculated as SiO₂ of 37%.

With respect to the obtained film, the same measurement as in Example 1 was carried out.

(1) The haze was 0.9%.

(2) The film had a pencil hardness of 9H, which was improved as compared with the film comprising the copolymer (A1) produced in Production Example 1.

(3) As the results of the tensile test, the elastic modulus was 790 MPa, the breaking stress was 40 MPa, the elongation was 40%, and the film had a sufficient strength as a film.

### Example 4

0.4 g of copolymer (A1) obtained in Preparation Example 1 was dissolved at room temperature in 2.4 g of MG and 0.6 g of DG. Then, 1.2 g of methyl silicate oligomer (tetramer on average, manufactured by TAMA CHEMICALS CO., LTD., tradename: MS51) as the alkoxysilane compound, 0.2 g of DG containing 0.02 g of a titanate compound (manufactured by Shin-Etsu Chemical Co., Ltd., tradename: D-20) as the catalyst, and further 0.08 g of hexamethylcyclotrisilazane, were added with stirring at room temperature to prepare composition (C4). Using composition (C4), a film having a thickness of 0.1 mm was obtained in the same manner as in Example 1. The obtained film had an amount as calculated as SiO₂ of 41%.

With respect to the obtained film, the same measurement as in Example 1 was carried out.

(1) The haze was 1.1%.

(2) The film had a pencil hardness of 8H, which was improved as compared with the film comprising the copolymer (A1) produced in Production Example 1.

### Example 5

0.4 g of copolymer (A1) obtained in Preparation Example 1 was dissolved at room temperature in 3.6 g of propylene glycol monomethyl ether. Then, 0.4 g of methyl silicate oligomer (tetramer on average, manufactured by TAMA CHEMICALS CO., LTD., tradename: MS51) as the alkoxysilane compound, 0.4 g of methyltrimethoxysilane oligomer (manufactured by Shin-Etsu Chemical Co., Ltd., tradename: KR500), 0.4 g of isopropanol-dispersed silica sol (manufactured by Nissan Chemical Industries, Ltd., tradename: IPA-ST-S) and 0.18 g of DG containing 0.018 g of a titanate compound (manufactured by Shin-Etsu Chemical Co., Ltd., tradename: D-20) as the catalyst, and further 0.07 g of hexamethylcyclotrisilazane, were added with stirring at room temperature to prepare composition (C5). Using composition (C5), a film having a thickness of 0.1 mm was obtained in the same manner as in Example 1. The obtained film had an amount as calculated as SiO₂ of 39%.

With respect to the obtained film, the same measurement as in Example 1 was carried out.

(1) The haze was 2.7%.

(2) The film had a pencil hardness of 8H, which was improved as compared with the film comprising the copolymer (A1) produced in Production Example 1.

(3) As the results of the tensile test, the elastic modulus was 1,039 MPa, the breaking stress was 21 MPa, the elongation was 5%, and the film was a transparent film having a high elastic modulus.

### Comparative Example 1

0.6 g of copolymer (A1) obtained in Preparation Example 1 was dissolved at room temperature in 6 g of ethanol. Then, 0.4 g of methyl silicate oligomer (tetramer on average, manufactured by TAMA CHEMICALS CO., LTD., tradename: MS51) was added to prepare a uniform solution, to which 0.8 g of pure water was added with stirring and then 0.3 g of 2N hydrochloric acid was added. The mixture was stirred at room temperature for one hour to obtain a composition. In the same manner as in Example 1, a 7 cm square film having a thickness of 0.12 mm was obtained, however, it was clouded and had a haze of 68%. The melting point was measured by differential scanning calorimetry (DSC), whereupon it was 203° C., which was substantially the same as the melting point of copolymer (A1) of 209° C., and it was confirmed that a crystalline phase of copolymer (A1) was phase-separated in the polysiloxane. Further, the surface of the film was observed with a scanning electron microscope (magnification: 1,000 times), whereupon particles of from 5 to 10 μm which seemed to be silica particles were confirmed as shown in FIG. 3.

It is considered that the interaction between silanol groups formed by hydrolysis of alkoxy groups and the hydroxy groups in copolymer (A1) was inhibited, whereby the crystalline phase of copolymer (A1) was phase-separated in the polysiloxane.

### INDUSTRIAL APPLICABILITY

The composition of the present invention is suitably applied to a material for coating material excellent in the weather resistance and the transparency, an optical material excellent in the transparency, a gas/liquid separation membrane material excellent in the water resistance, a gas barrier material, a sealing material for a solar cell, a surface protective sheet material, a hydrophilic porous material, etc. Particularly, the film of the present invention is excellent in the transparency, the heat resistance and the surface hardness and is thereby useful as an optical material such as a protective cover for a liquid crystal display, a solar cell, etc., a transparent flexible substrate or a Fresnel lens. It is also useful as a material for hard coating, low-reflection coating or antifouling coating, or a coating material for e.g. protective coating for an electronic substrate metal wiring or a device.

This application is a continuation of PCT Application No. PCT/JP2012/075854, filed on Oct. 4, 2012, which is based upon and claims the benefit of priority from Japanese Patent Application No. 2011-220922 filed on Oct. 5, 2011. The contents of those applications are incorporated herein by reference in their entireties.

What is claimed is:

1. A composition comprising a fluorinated olefin/vinyl alcohol copolymer, an alkoxysilane compound, a solvent and a hydrolysis/condensation catalyst;
wherein the alkoxysilane compound is a compound represented by the following formula (1) and/or its oligomer; and
the solvent is at least one member selected from the group consisting of a C₃₋₁₀ ketone compound, a C₂₋₁₀ nitrile compound, a C₃₋₁₀ amide compound in which a hydrogen atom bonded to the nitrogen atom may be substituted by a C₁₋₅ alkyl group, and an ether compound represented by the following formula (2):
R²ₓSi(OR³)₄₋ₓ (1)
wherein x is an integer of from 0 to 2, R² is a group selected from the group consisting of a hydrogen atom, a C₁₋₁₀ alkyl group, a C₂₋₁₀ fluoroalkyl group and a C₆₋₁₂ aryl group, and R³ is a C₁₋₆ alkyl group or a cycloalkyl group;
R⁴—(OCHR⁶CH₂)ₙ—OR⁵ (2)
wherein R⁴ is a C₁₋₅ alkyl group, R⁵ is a hydrogen atom or a C₁₋₅ alkyl group, R⁶ is a hydrogen atom or a hydroxy group, and n is an integer of from 1 to 5.

2. The composition according to claim 1, wherein R⁶ in the formula (2) is a hydrogen atom.

3. The composition according to claim 1, wherein the fluorinated olefin/vinyl alcohol copolymer has a weight average molecular weight of from 50,000 to 1,000,000.

4. The composition according to claim 1, wherein the fluorinated olefin/vinyl alcohol copolymer is a copolymer containing repeating units represented by the following formula (3) and repeating units represented by the following formula (4):
—(CF₂CFX¹)— (3)
—(CH₂CH(OH))— (4)
wherein X′ is a fluorine atom, a chlorine atom, a trifluoromethyl group or —OCₐF₂ₐ₊₁ (wherein a is an integer of from 1 to 3).

5. The composition according to claim 4, wherein in the fluorinated olefin/vinyl alcohol copolymer, the molar ratio of the repeating units represented by the formula (3) to the repeating units represented by the formula (4) is from 40/60 to 60/40.

6. The composition according to claim 4, wherein in the fluorinated olefin/vinyl alcohol copolymer, the alternating copolymerization ratio of the repeating units represented by the formula (3) and the repeating units represented by the formula (4) is at least 95%.

7. The composition according to claim 1, wherein the solvent contains at least one member selected from the group consisting of acetone, acetonitrile, 2-methoxypropionitrile, N,N-dimethylformamide, ethylene glycol monomethyl ether, ethylene glycol monoethyl ether, ethylene glycol dimethyl ether, diethylene glycol dimethyl ether, propylene glycol monomethyl ether, propylene glycol monoethyl ether and propylene glycol monobutyl ether.

8. The composition according to claim 1, wherein the alkoxysilane compound is at least one member selected from the group consisting of methyltrimethoxysilane, phenyltrimethoxysilane, tetramethoxysilane, tridecafluorooctyltrimethoxysilane and their oligomers.

9. The composition according to claim 1, wherein the mass ratio of the fluorinated olefin/vinyl alcohol copolymer to the alkoxysilane compound is from 5:95 to 95:5, and the mass ratio of the total mass of the fluorinated olefin/vinyl alcohol copolymer and the alkoxysilane compound to the solvent is from 95:5 to 1:99.

10. The composition according to claim 1, wherein the hydrolysis/condensation catalyst is a sulfonic acid compound.

11. The composition according to claim 1, which further contains water.

12. A cured product obtained by heating the composition as defined in claim 1 to remove the solvent.

13. The cured product according to claim 12, wherein the temperature at which the composition is heated is from 40 to 200° C.

14. A film comprising the cured product as defined in claim 12.

15. A method for producing a film, which comprises forming the composition as defined in claim 1 into a film by a casting method, followed by heating to remove the solvent.

16. A method for producing a composition, which comprises dissolving a fluorinated olefin/vinyl alcohol copolymer and an alkoxysilane compound in at least one solvent selected from the group consisting of a C₃₋₁₀ ketone compound, a C₂₋₁₀ nitrile compound, a C₃₋₁₀ amide compound in which a hydrogen atom bonded to the nitrogen atom may be substituted by a C₁₋₅ alkyl group, and an ether compound represented by the following formula (2), to obtain s solution, and adding a hydrolysis/condensation catalyst and water to the obtained solution to let the alkoxysilane compound be partially hydrolyzed/condensed, wherein the alkoxysilane compound is a compound represented by the following formula (1) and/or its oligomer:
R²ₓSi(OR³)₄₋ₓ (1)
wherein x is an integer of from 0 to 2, R² is a group selected from the group consisting of a hydrogen atom, a C₁₋₁₀ alkyl group, a C₂₋₁₀ fluoroalkyl group and a C₆₋₁₂ aryl group, and R³ is a C₁₋₆ alkyl group or a cycloalkyl group;
R⁴—(OCHR⁶CH₂)ₙ—OR⁵ (2)
wherein R⁴ is a C₁₋₅ alkyl group, R⁵ is a hydrogen atom or a C₁₋₅ alkyl group, R⁶ is a hydrogen atom or a hydroxy group, and n is an integer of from 1 to 5.

17. The method for producing a composition according to claim 16, wherein R⁶ in the formula (2) is a hydrogen atom.
